(19) United States
(12) Patent Application Publication
(10) Pub. No.: US 2023/0059509 A1
(43) Pub. Date: Feb. 23, 2023

(54) Power Conversion Device and Mechatronic Power Conversion Device

(71) Applicant: Hitachi Astemo, Ltd., Hitachinaka-shi, Ibaraki (JP)

(72) Inventors: Akira MIMA, Tokyo (JP); Yukio HATTORI, Hitachinaka-shi, Ibaraki (JP); Eiichi IDE, Tokyo (JP)

(21) Appl. No.: 17/797,148

(22) PCT Filed: Oct. 23, 2020
(86) PCT No.: PCT/JP2020/039916

§ 371 Date: Aug. 3, 2022

(30) Foreign Application Priority Data
Mar. 23, 2020 (JP) 2020-050581

(51) Int. Cl. H02M 7/00; H02K 11/33; H02K 5/22

(52) U.S. Cl. CPC H02M 7/003; H02K 11/33; H02K 5/225; H02K 11/215

(57) ABSTRACT

An object of the present invention is to provide a power conversion device configured to attain suppression of heat concentration and miniaturization of the device. The power conversion device 40 includes a power module 17 for converting dc power into ac power, a first circuit substrate (power circuit substrate) 16 including a capacitor 31 for smoothing the dc power, and a casing 20 for storing the power module 17 and the first circuit substrate 16. Either the first circuit substrate 16 or the power module 17 is disposed on an inner surface 20bb of a side wall 20b having an outer wall surface 20ba of the casing 20, and the other is disposed on a predetermined inner wall surface 20a of the casing 20 to form an angle with the inner surface 20bb.

### TECHNICAL FIELD

The present invention relates to a power conversion device used for converting dc power into ac power, or ac power into dc power. More specifically, the present invention relates to a cooling structure suitable for a power conversion device of electromechanical type (hereinafter referred to as mechatronic power conversion device).

### BACKGROUND ART

Japanese Patent Application Laid-Open No. 2019-41507 (Patent Literature 1) discloses a motor device as the mechatronic power conversion device used for an electric power steering system for automobile (refer to paragraph 0017).

The disclosed motor device includes a motor having a motor shaft, a first control substrate and a second control substrate each provided as a control substrate constituting the circuit for controlling motor driving operations, and a housing that stores the motor, the first and the second control substrates. A first power circuit and a first control circuit are combined and mounted on the first control substrate. A second power circuit and a second control circuit are combined and mounted on the second control substrate. The motor device has the first and the second control substrates intersecting a radial direction orthogonal to an axial direction of the motor (refer to Abstract).

Specifically, each of the control substrates (first and second control substrates) includes multiple transistors and multiple capacitors, which constitute the respective power circuits (first and second power circuits), and multiple integrated circuits constituting the respective control circuits (first and second control circuits). Capacitors are disposed on surfaces (mount surfaces) at one end surface side of the control substrates. Transistors and integrated circuits are disposed on surfaces (mount surfaces) at the other end surface side of the control substrates (see paragraph 0029).

In the state that the respective mount surfaces on which transistors and integrated circuits are disposed are directed opposite to the main part of the heat sink for facilitating heat dissipation of the components constituting the motor device, the control substrates are arranged to interpose the main body of the heat sink from the thickness direction so that the heat sink is shared. The motor device as disclosed in Patent Literature 1 is configured to suppress enlargement of its size in the radial direction of the motor.

### CITATION LIST

### Patent Literature

Patent Literature 1: Japanese Patent Application Laid-Open No. 2019-41507

### SUMMARY OF INVENTION

### Technical Problem

The disclosed motor device is configured to allow contact of the power circuit components constituting the respective power circuits (power module including transistor, capacitor, and the like) for power transfer with the single heat sink disposed in the radial center of the housing (on the extended line of the motor axis) concentratedly. Accordingly, the power components constituting the respective power circuits thermally interfere with one another. The above-described configuration causes the problem of heat concentration in the power components as the progress of device miniaturization.

The present invention has been made in light of the problem as described above. An object of the present invention is to provide the power conversion device aiming at suppression of heat concentration and miniaturization of the device.

### Solution to Problem

In order to attain the above-described object, the present invention provides a power conversion device which includes a power module for converting dc power into ac power, a first circuit substrate having a capacitor for smoothing the dc power, and a casing for storing the power module and the first circuit substrate. One of the first circuit substrate and the power module is disposed on an inner surface of a side wall having an outer wall surface of the casing, and the other is disposed on a predetermined inner wall surface of the casing to form an angle with the inner surface.

### Advantageous Effects of Invention

The present invention minimizes heat interference between the power module as a heat generating component and a smoothing capacitor with low heat resistance so that the smoothing capacitor in the highly densified mount state is efficiently cooled, resulting in improved reliability and prolonged life. Problems, structures, and advantageous effects other than those described above will be clarified by explanations of an embodiment to be described below.

### BRIEF DESCRIPTION OF DRAWINGS

FIG. 1 is a sectional view of a mechatronic power conversion device according to an embodiment of the present invention.

FIG. 2 is a block diagram illustrating a circuit structure of an inverter section of the mechatronic power conversion device according to the embodiment of the present invention.

FIG. 3 is an exploded stereoscopic view of the mechatronic power conversion device according to the embodiment of the present invention.

FIG. 4 is a partial sectional view representing the process of mounting a power circuit substrate according to the embodiment of the present invention.

FIG. 5 is a partial sectional view representing a modified example of an inner structure of the inverter section according to the embodiment of the present invention.

FIG. 6 is a partial sectional view representing a modified example of an inner structure of the inverter section according to the embodiment of the present invention.

FIG. 7 is a sectional view of the mechatronic power conversion device representing a modified example of an inner structure of the inverter section according to the embodiment of the present invention.

### DESCRIPTION OF EMBODIMENT

Recently the power conversion device in the form of the inverter unit has been demanded to attain higher output density by facilitating further reduction both in size and weight of the power conversion device. In the case of the mechatronic power conversion device having both the inverter unit and the motor stored in the same casing (housing), reduction in size and weight of such device has been increasingly demanded owing to limited mount space. The mechatronic power conversion device can be exemplified by the automobile electric power steering device. The automobile electric power steering device is configured to detect the rotating direction and the rotating torque of the steering shaft connected to the steering wheel operated by the driver, and generate the steering assist torque by driving the electric motor for alignment with the rotating direction of the steering shaft based on the detected values. The mechatronic power conversion device has the electric motor and the inverter unit for controlling the electric motor stored in the same casing.

If the power circuit components (power module including the transistor, capacitor, and the like) which constitute the respective power circuits for power conversion come in contact with the single heat sink disposed on the radial center of the housing (on the extended line of the motor shaft) concentratedly, heat interference occurs in the power circuit components which constitute the respective power circuits. If the motor shaft is located on the center of the housing, the thermally connected portion between the heat sink and the housing is limited because the magnetic sensor substrate for detecting the rotating angle of the motor shaft is disposed on the extended line of the motor shaft. This makes it difficult to secure the heat dissipation path.

As device miniaturization proceeds, the mechatronic power conversion device is required to attain higher mount density of the components to be installed. As a result, the power module as the heat generating component and the smoothing capacitor are disposed adjacently, resulting in heat interference. The electrolytic capacitor with large capacity per unit area is employed as the smoothing capacitor component to satisfy requirements of both miniaturization and cost reduction. The use of the electrolytic capacitor, however, is disadvantageous because of low heat resistance.

As the device miniaturization proceeds, the problem of heat concentration in the power circuit components occurs, leading to deteriorated reliability of the power circuit component. The following embodiment will be described with respect to the mechatronic power conversion device which ensures suppression of heat concentration and miniaturization of the device.

Hereinafter, an embodiment of the mechatronic conversion device according to the present invention will be described referring to the drawings. The same elements as those in the drawings and embodiments are designated with the same reference signs, and repetitive explanations of those elements will be omitted.

### First Embodiment

A mechatronic power conversion device 10 employed for automobile electric power steering device includes a connector section 11 for inputting signals and power, a lid 13 for storing the connector section 11, a control substrate (second circuit substrate) 14, a power circuit substrate (first circuit substrate) 16 for transferring power from a not shown battery, a power module 17 for converting dc power from the battery into ac power, an electric motor 41 for converting power output from an inverter into a drive torque, and a casing (housing) 20 for storing the foregoing components.

In addition to a semiconductor relay 30 and a smoothing capacitor 31, a rectifier coil and a shunt resistor for detecting current are mounted on the power circuit substrate 16. That is, the first circuit substrate (power circuit substrate) 16 includes the capacitor 31 for smoothing the dc power, and a relay for conduction/cut-off of the dc power. A microcomputer 21 for outputting control commands in accordance with the current value detected by the shunt resistor, a predriver 22 for driving the power module 17 in response to the command from the microcomputer, and a power supply control circuit 23 are mounted on the control substrate 14. The power module 17 which is called an inverter module or a power semiconductor module is configured to convert dc power into ac power.

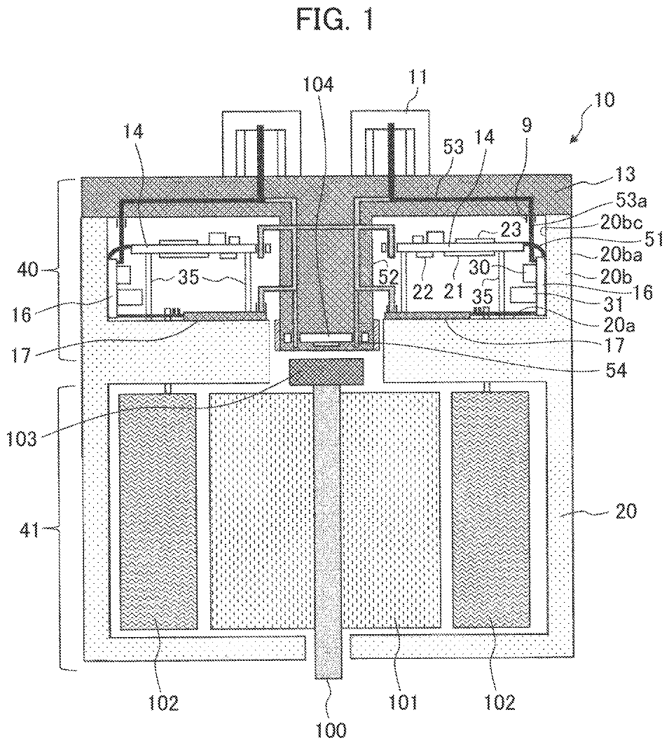

Referring to FIG. 1, an explanation will be made with respect to a structure of the mechatronic power conversion device 10 according to an embodiment of the present invention. FIG. 1 is a sectional view of the mechatronic power conversion device according to the embodiment of the present invention.

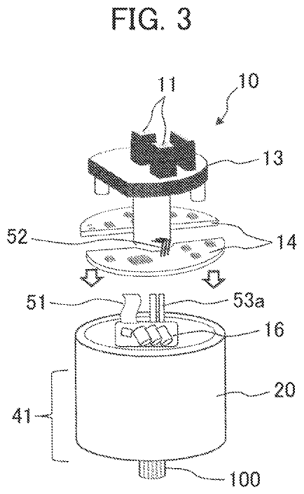

Explanations will be made by specifying the up-down direction in the following embodiment including other embodiments. The up-down direction is specified based on the one illustrated in FIG. 1 without specifying the up-down direction of the mechatronic power conversion device 10 in the mounted state. The up-down directions of FIGS. 3, and 5 to 7 correspond to the one as illustrated in FIG. 1.

The mechatronic power conversion device 10 according to the embodiment includes an inverter section 40 and a motor section 41. The inverter section 40 is also called the power conversion device.

The inverter section 40 includes a connector section 11 (input connector section) 11 for inputting rotation torque signals from a not shown steering wheel, and battery power, the lid 13 which stores an electric wiring, the control substrate 14, the power circuit substrate 16, and the power module 17. The motor section 41 is constituted by the electric motor. Both the inverter section 40 and the motor section 41 are stored in the metal casing 20. The lid 13 made of resin or the like may be constituted as a member separate from the casing 20. However, the lid constitutes a part of the housing together with the casing 20.

The motor section 41 includes a motor shaft 100 for torque transfer, a rotor 101 integrated with the motor shaft 100, and a stator 102 for generating motive power by electric power received from the inverter section 40. A magnet 103 for transferring a rotation angle is mounted on the axial center of the motor shaft 100. A sensor substrate 104 for detecting the rotation angle of the motor is mounted on a position opposite to the magnet 103.

The rotation angle signal from the sensor substrate 104 is transferred to the control substrate 14 via a wiring 54 stored in the lid 13. The microcomputer 21 mounted on the control substrate 14 sends a control command to the predriver 22 mounted on the same substrate in accordance with the rotation angle. Upon reception of the control command, the predriver 22 drives the power module 17.

A power supply control circuit 23 mounted on the control substrate 14 controls the semiconductor relay 30 mounted on the power circuit substrate 16 in accordance with the input battery power, and supplies dc power to the smoothing capacitor 31 mounted on the power circuit substrate 16.

The power module 17 converts the dc power accumulated in the smoothing capacitor 31 into ac power, and transfers the ac power to the motor section 41.

The power module 17 generates Joule heat owing to conduction loss and switching loss which occur therein upon conversion of dc power into ac power. Temperature rise occurs in the power module 17 to result in destruction unless the generated Joule heat is dissipated. For that reason, the power module 17 is brought into contact with the metal casing 20 for heat dissipation. The metal casing 20 ensures to conduct heat efficiently for heat dissipation through the outer surface of the metal casing 20.

Meanwhile, the smoothing capacitor 31 is mounted on the power circuit substrate 16. The power circuit substrate 16 also generates Joule heat owing to the loss such as internal resistance existing in the smoothing capacitor 31. The power circuit substrate 16 is also required to be brought into contact with the casing 20 for heat dissipation. Preferably, the electrolytic capacitor is used as the smoothing capacitor 31 for attaining the cost reduction and capacity enlargement. It has been widely known that the electrolytic capacitor cannot exhibit sufficient heat resistance. Accordingly, efficient dissipation of heat generated in the smoothing capacitor 31 has been demanded.

It is essential for the smoothing capacitor 31 to minimize the fanned heat from the power module 17 as much as possible. In this embodiment, the power module 17 is disposed on a predetermined inner wall surface 20a of the casing 20, through which heat is dissipated. Preferably, the power circuit substrate 16 is disposed on an inner side surface (inner wall surface or inner surface) 20bb of a side wall 20b having an outer wall surface (outer surface) 20ba in contact with an outer part of the device 10. An angle is formed between the inner wall surface 20a on which the power module 17 is displayed, and the inner side surface 20bb.

In other words, the power conversion device (inverter section) 40 of the embodiment includes the power module 17 for converting dc power into ac power, the first circuit substrate (power circuit substrate) 16 having the capacitor 31 for smoothing the dc power, and the casing 20 for storing the power module 17 and the first circuit substrate 16. The first circuit substrate 16 is disposed on the inner surface 20bb of the side wall 20b having the outer wall surface 20ba. The power module 17 is disposed on the predetermined inner wall surface 20a of the casing 20, which forms the angle with the inner surface 20bb.

In this embodiment, the predetermined inner wall surface 20a is formed toward radially inward from the inner side surface 20bb of the side wall 20b of the metal casing 20. The side wall 20b is a wall part which extends along the axial direction of the motor shaft 100 parallel thereto. Each of the outer wall surface (outer surface) 20ba and the inner side surface (inner wall surface or inner surface) 20bb is a wall surface which extends along the axial direction of the motor shaft 100 parallel thereto.

The control substrate 14 is disposed on the surface which is different from the respective surfaces on which the power circuit substrate 16 and the power module 17 are disposed. That is, the control substrate 14 is located at the position apart from the power circuit substrate 16 and the power module 17 in the axial direction of the motor shaft 100. In other words, the power conversion device (inverter section) 40 includes the second circuit substrate (control substrate) 14 having a control circuit for outputting the drive signal of the power module 17 and the control signal of the relay 30. The second circuit substrate 14 is disposed opposite to the predetermined inner wall surface 20a while having the power module 17 intervening therebetween. Especially, in this embodiment, it is disposed at the side opposite to the motor section 41 to the power circuit substrate 16 and the power module 17. In this embodiment, the control substrate 14 is supported above the predetermined wall surface 20a by multiple supports 35.

The foregoing structure allows suppression of the direct fanned heat from the power module 17 to a minimum even in the case of highly densified arrangement of components as a result of miniaturization.

The structure may lower the temperature of the smoothing capacitor 31 so that prolonged life of the capacitor component can be expected.

The control substrate 14 connected to the semiconductor relay 30 via a first wiring 51 executes ON/OFF control of the semiconductor relay 30. The control substrate 14 connected to the power module 17 via a second wiring 52 controls switching operations of the power module 17. That is, the power conversion device (inverter section) 40 includes the second circuit substrate (control substrate) 14 having the control circuit for outputting the drive signal of the power module 17 and the control signal of the relay 30, the first wiring 51 which connects the second circuit substrate 14 and the first circuit substrate (power circuit substrate) 16 for transferring the control signal of the relay 30 to the first circuit substrate 16, and the second wiring 52 which connects the second circuit substrate 14 and the power module 17 for driving the power module 17.

The dc power from the battery is connected to the power circuit substrate 16 via a third wiring 53. It is preferable to use the third wiring 53 with its cross-sectional area larger than that of the first wiring 51 and the second wiring 52 for power transfer. Preferably, the third wiring is disposed apart from the first wiring 51 and the second wiring 52 for transferring the control signal to avoid the influence of noise generated upon operation of the power module 17.

The mechatronic power conversion device 10 of the embodiment has a fully redundant structure for high reliability. In the inverter section 40, 2 sets of circuit components each including the control substrate 14, the power circuit substrate 16 and the power module 17 are disposed in horizontally symmetrical arrangement to the motor shaft 100.

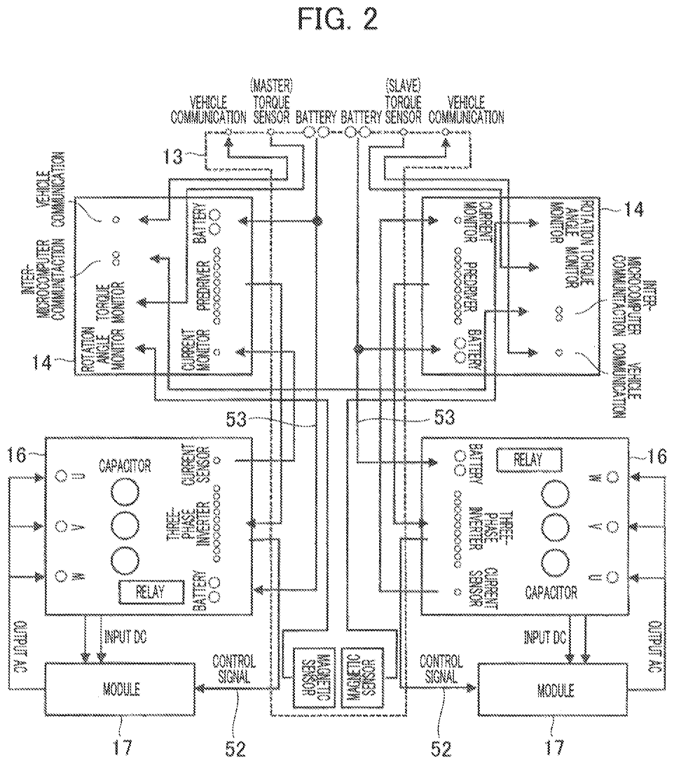

Referring to FIG. 2, an explanation will be made with respect to the circuit structure of the inverter section 40 of the mechatronic power conversion device 10 according to the embodiment. FIG. 2 is a block diagram illustrating the circuit structure of the inverter section of the mechatronic power conversion device according to the embodiment of the present invention. The circuit structure as illustrated in FIG. 2 is exemplified by the redundant structure.

The inverter section 40 has the redundant structure including 2 sets of identical circuits for securing high reliability. Specifically, the structure is formed by duplicating the system including the control substrate 14, the power circuit substrate 16, and the power module 17. For example, assuming that the inverter section is used for an automobile electric power steering device, even in the case of destruction of one of the systems owing to some sort of causes during traveling of the automobile, the other system can continue the operation substitutionally. Although the redundant structure attains the high reliability, the number of parts is increased, thus demanding higher mount densification. The foregoing structure of the mechatronic power conversion device 10 improves component thermal reliability to allow further improvement in the product safety.

Referring to FIG. 3, an explanation will be made with respect to the process of assembling the mechatronic power conversion device 10 according to the embodiment. FIG. 3 is an exploded stereoscopic view of the mechatronic power conversion device according to the embodiment of the present invention.

The power circuit substrate 16 on which the semiconductor relay 30 and the smoothing capacitor 31 are mounted is disposed on the inner side surface 20bb of the side wall 20b of the metal casing 20 assembled with the motor section 41 and the power module 17. The control substrate 14 is then mounted and connected to the first wiring 51. The first wiring 51 connects the control substrate 14 and the power circuit substrate 16 through a wiring connector or soldering. The lid 13 which stores the second wiring 52 is mounted on the metal casing 20. In the process of connecting the third wiring 53, a part 53a of the third wiring 53 is preliminarily connected to the power circuit substrate 16. Meanwhile, a part of the third wiring 53, which is stored in the lid 13 is connected to a connector 9 stored in the lid 13. Then the part 53a of the third wiring 53 is squeezed into the connector 9 when mounting the lid 13.

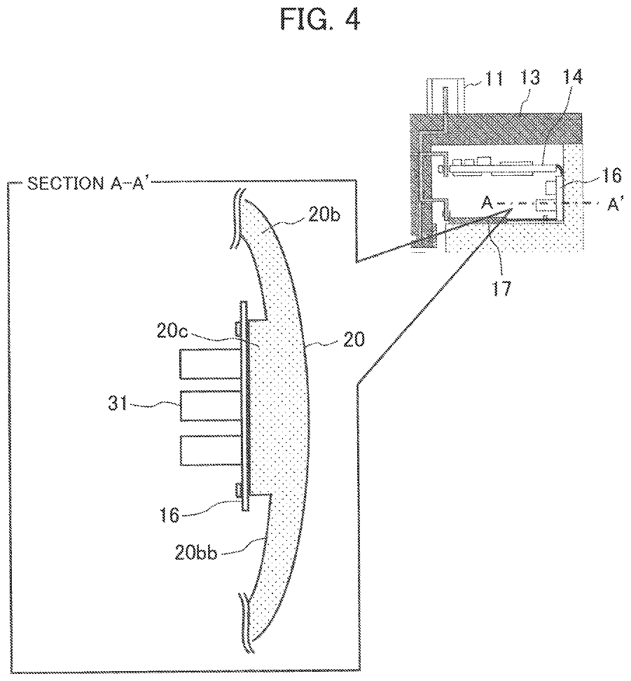

Referring to FIG. 4, an explanation will be made with respect to the process of mounting the power circuit substrate 16 according to the embodiment. FIG. 4 is a partial sectional view representing the process of mounting the power circuit substrate according to the embodiment of the present invention.

As FIG. 3 illustrates, the metal casing 20 of the mechatronic power conversion device 10 has a cylindrical shape adapted to the motor structure. Accordingly, the inner wall part of the metal casing 20, on which the power circuit substrate 16 is mounted has the cylindrical surface.

Meanwhile, the power circuit substrate 16 on which the smoothing capacitor 31 is disposed is formed into a flat plate-like shape. In this embodiment, as the section A-A′ of FIG. 4 illustrates, for the purpose of mounting the power circuit substrate 16, the thickness of the side wall 20b of the metal casing 20, which is in contact with the power circuit substrate 16 is larger than that of the part which is not in contact with the power circuit substrate 16. Such part in contact with the power circuit substrate 16 is flattened. That is, the inner surface (inner side surface) 20bb of the side wall 20b of the casing 20 includes a seat (thick portion) 20c having a flat surface (mount surface) on which the power circuit substrate 16 is mounted. The foregoing structure allows contact between the power circuit substrate 16 having the smoothing capacitor 31 disposed thereon and the metal casing 20 over an entire surface of the substrate. This makes it possible to dissipate generated heat to the metal casing 20 efficiently.

The power circuit substrate 16 may be connected to the seat 20c via a fixing member such as a screw. It is possible to connect the power circuit substrate 16 to the seat 20c via the adhesive with high heat conductivity. It is also possible to intervene the heat-dissipating grease with high heat conductivity between the power circuit substrate 16 and the seat 20c.

### Modified Example 1

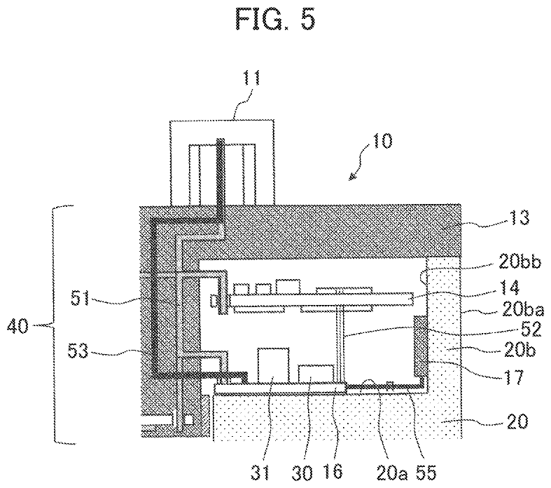

Referring to FIG. 5, an explanation will be made with respect to a modified example of a mount structure of the inverter section 40 of the mechatronic power conversion device 10 according to the embodiment. FIG. 5 is a partial sectional view representing the modified example of an inner structure of the inverter section according to the embodiment of the present invention.

In the structure of the modified example, which is different from that of the embodiment as described above, the power module 17 is mounted on the inner side surface (inner wall surface or inner surface) 20bb of the side wall 20b of the metal casing 20 instead of the predetermined inner wall surface 20a of the metal casing 20. The power circuit substrate 16 on which the smoothing capacitor 31 is mounted is disposed on the predetermined inner wall surface 20a. That is, the structure of the modified example interchanges mount positions between the power circuit substrate 16 and the power module 17 according to the foregoing embodiment.

Specifically, the power conversion device (inverter section) 40 of the modified example includes the power module 17 for converting dc power into ac power, the first circuit substrate (power circuit substrate) 16 having the capacitor 31 for smoothing the dc power, and the casing 20 for storing the power module 17 and the first circuit substrate 16. The power module 17 is disposed on the inner surface 20bb of the side wall 20b having the outer wall surface (outer surface) 20ba. The first circuit substrate 16 is disposed on the predetermined inner wall surface 20a of the casing 20, which forms an angle with the inner surface 20bb.

In this case, it is preferable to mount the power module 17 on the seat 20c as illustrated in FIG. 4.

Similar to the foregoing embodiment, the structure of the modified example as illustrated in FIG. 5 allows distribution of cooling paths of the power circuit substrate 16 and the power module 17. Accordingly, the cooling effect similar to the one derived from the foregoing embodiment can be expected.

In the modified example, the power circuit substrate 16 is mounted on the inner wall surface of the metal casing 20. It is therefore preferable to store the third wiring 53 for supplying dc power from the battery in the lid 13. Meanwhile, it is preferable to dispose the second wiring 52 for connecting the control substrate 14 and the power module 17 on the position closer to the outer wall side of the metal casing 20 than the position of the third wiring 53. Specifically, the second wiring 52 connects the control substrate 14 and the power circuit substrate 16. A fourth wiring 54 connects the power circuit substrate 16 and the power module 17. That is, the power module 17 is connected to the second wiring 52 via a fourth wiring 55 and the power circuit substrate 16. It is preferable to store the first wiring 51 for connecting the control substrate 14 and the semiconductor relay 30 in the lid 13.

The lid 13 constitutes a connector assembly which stores the connector section 11, and the electric wirings 51, 52, 53 and the like, which are connected to the connector section 11. That is, the power conversion device (inverter section) 40 includes the third wiring 53 for supplying dc power, and the connector assembly 13 for storing the third wiring 53. At least one of the first wiring 51 and the second wiring 52 is stored in the connector assembly 13.

In the case of the inverter with redundant structure, a set of the components as illustrated in FIG. 5 and another set of the components are arranged point symmetrically to an axis as the motor shaft 100.

### Modified Example 2

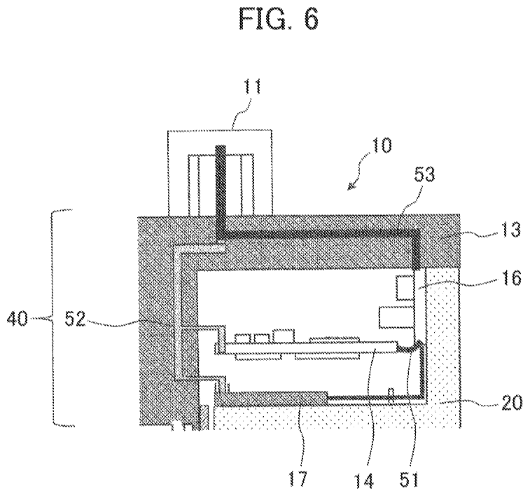

Referring to FIG. 6, an explanation will be made with respect to a modified example of a mount structure of the inverter section 40 of the mechatronic power conversion device 10 according to the embodiment. FIG. 6 is a partial sectional view representing the modified example of an inner structure of the inverter section according to the embodiment of the present invention.

In the structure of the modified example, which is different from that of the embodiment as described above, the control substrate 14 is located closer to the motor section 41 in the metal casing 20 than the power circuit substrate 16. In other words, the power circuit substrate 16 is disposed opposite to the motor section 41 to the control substrate 14. According to the structure of the modified example, the first wiring 51 connects the control substrate 14 and the power circuit substrate 16. The first wiring 51 formed as, for example, a flexible substrate can be integrally formed with the control substrate 14 and the power circuit substrate 16 through the manufacturing process on the same substrate.

As illustrated in FIG. 3, the mechatronic power conversion device 10 according to the embodiment has the motor section 41 mounted at the lower part. The integrated control substrate 14 and the power circuit substrate 16 are arranged vertically to each other by bending the first wiring 51 so that they can be mounted onto the motor section 40 from an upper opening of the metal casing 20. In this way, as the control substrate 14 and the power circuit substrate 16 can be visually confirmed from the upper opening of the metal casing 20, they can be easily fixed to predetermined positions.

The structure of the embodiment is advantageous in simplifying the assembly process.

### Modified Example 3

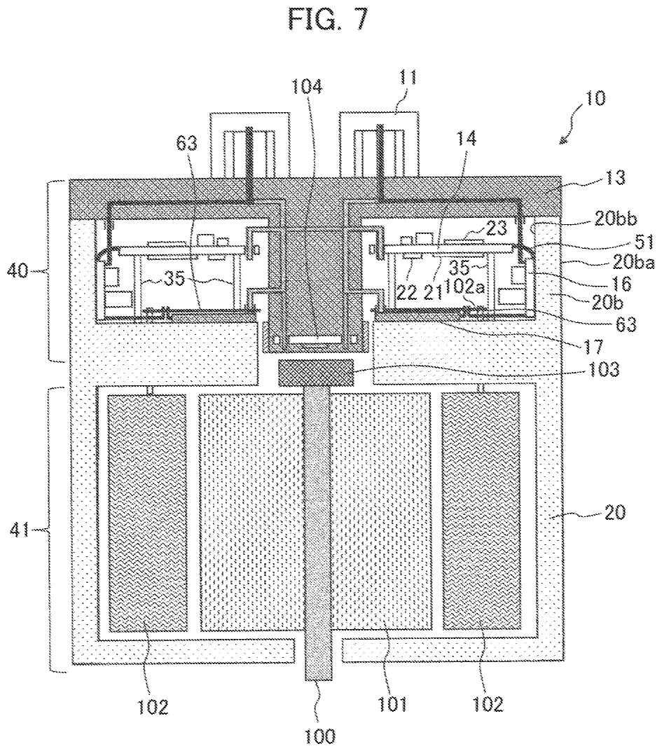

Referring to FIG. 7, an explanation will be made with respect to a modified example of a mount structure of the mechatronic power conversion device 10 according to the embodiment. FIG. 7 is a sectional view of the mechatronic power conversion device representing the modified example of an inner structure of the inverter section according to the embodiment of the present invention.

Referring to the structure of the modified example, which is different from that of the embodiment as described above, a bus bar substrate 63 is added to be shared for connecting the power module 17 and a winding 102a of the motor section 41, and connecting the power circuit substrate 16 and the power module 17. The bus bar substrate 63 is formed by mounting a dc terminal and an ac terminal of the power module 17 on one substrate.

That is, the mechatronic power conversion device 10 of the embodiment includes the bus bar substrate 63 having the dc terminal and the ac terminal of the power module 17 mounted on one substrate. The bus bar substrate 63 is connected to the first circuit substrate (power circuit substrate) 16 and the motor section 41.

The bus bar substrate 63 of this modified example can be applied to structures of the modified examples 1 and 2.

Referring to the structure as illustrated in FIG. 1, each of the foregoing connections is carried out separately. In this modified example, those connections can be carried out using the single member in the form of the shared bus bar substrate 63. A unit of the bus bar substrate 63 can be mounted upon assembly without requiring connection of variously shaped bus bars. This makes it possible to ease complicated assembly operations.

Each of the power conversion devices 40 according to the embodiment and the modified examples thereof includes the power module 17 for converting dc power into ac power, the first circuit substrate (power circuit substrate) 16 having the capacitor 31 for smoothing the dc power, and the casing 20 for storing the power module 17 and the first circuit substrate 16. One of the first circuit substrate 16 and the power module 17 is disposed on the inner surface 20bb of the side wall 20b having the outer wall surface 20ba of the casing 20. The other one is disposed on the predetermined inner wall surface 20a of the casing 20, which forms the angle with the inner surface 20bb.

The inner surface 20bb of the side wall 20b of the casing 20 has the thick portion (seat) 20c with flattened surface, on which one of the first circuit substrate 16 and the power module 17 is mounted.

The mechatronic power conversion device 10 includes the power conversion device for converting dc power into ac power, the motor section 41 driven by the converted ac power. The power conversion device exemplified by the above-described power conversion device 40 according to the embodiment and the modified examples thereof. The casing 20 of the power conversion device 40 is integrally formed with the housing for storing the motor section 41.

The present invention which is not limited to the aforementioned embodiment includes various kinds of modifications. For example, the above-described embodiment has been described in detail for easy understanding of the present invention. Therefore, it is not necessarily limited to be configured to have all the components as described above. It is possible to add, eliminate, and replace a part of the structure according to the embodiment to, from, and with another structure.

### LIST OF REFERENCE SIGNS

10: mechatronic power conversion device
11: connector section
13: lid
14: control circuit substrate (second circuit substrate)
16: power circuit substrate (first circuit substrate)
17: power module
20: metal casing
21: microcomputer
22: predriver
23: power supply control circuit
30: semiconductor relay
31: smoothing capacitor
40: inverter section (power conversion device)
41: motor section
51: first wiring (connecting control circuit substrate and power circuit substrate)
52: second wiring (connecting control circuit substrate and power module)
53: third wiring (connecting battery and power circuit substrate)
63: bus bar substrate
100: motor shaft
101: rotor
102: stator
103: magnet (for detecting rotation angle)

1. A power conversion device, comprising:
a power module for converting dc power into ac power;
a first circuit substrate having a capacitor for smoothing the dc power; and
a casing for storing the power module and the first circuit substrate, wherein:
one of the first circuit substrate and the power module is disposed on an inner surface of a side wall having an outer wall surface of the casing, and the other is disposed on a predetermined inner wall surface of the casing to form an angle with the inner surface.

2. The power conversion device according to claim 1, wherein the first circuit substrate includes the capacitor for smoothing the dc power, or a relay for conducting and shutting off the dc power.

3. The power conversion device according to claim 2, comprising:
a second circuit substrate including a control circuit for outputting a drive signal of the power module, and a control signal of the relay;
a first wiring for connecting the second circuit substrate and the first circuit substrate to transfer the control signal of the relay to the first circuit substrate; and
a second wiring for connecting the second circuit substrate and the power module to drive the power module.

4. The power conversion device according to claim 2, comprising a second circuit substrate including a control circuit for outputting a drive signal of the power module, and a control signal of the relay, wherein the second circuit substrate is disposed on a position opposite to the predetermined inner wall surface having the power module intervening between the second circuit substrate and the predetermined inner wall surface.

5. The power conversion device according to claim 1, wherein the inner surface of the side wall of the casing has a thick portion with a flat surface on which one of the first circuit substrate and the power module is mounted.

6. The power conversion device according to claim 3, comprising a third wiring for supplying the dc power, and a connector assembly for storing the third wiring, wherein at least one of the first wiring and the second wiring is stored in the connector assembly.

7. A mechatronic power conversion device, comprising:
a power conversion device for converting dc power into ac power; and
a motor section driven by the converted ac power, wherein:
the power conversion device according to claim 1 is provided; and
the casing is integrated with a housing for storing the motor section.

8. The mechatronic power conversion device according to claim 7, comprising a bus bar substrate formed by mounting a dc terminal and an ac terminal of the power module on one substrate, wherein the bus bar substrate is connected to the first circuit substrate and the motor section.
